(19) United States
(12) Patent Application Publication
(10) Pub. No.: US 2002/0173975 A1
(43) Pub. Date: Nov. 21, 2002

(54) Litigation management

(76) Inventor: Markham R. Leventhal, Miami, FL (US)

Correspondence Address: DAVID L. FEIGENBAUM, Fish & Richardson P.C., 225 Franklin Street, Boston, MA, 02110-2804, US

(21) Appl. No.: 09/859,006

(22) Filed: May 16, 2001

(51) Int. Cl. G06F 17/60; G06F 7/00

(52) U.S. Cl. 705/1; 707/1

(57) ABSTRACT

Information useful for simultaneously managing progress of multiple litigations is stored on a server. The information for each of at least some of the litigations is stored for a period of time that extends beyond the resolution of the litigation. At least some of the stored information is made available to authorized users through a user interface expressed in mark-up language pages.

### BACKGROUND

This invention relates to litigation management.

Evidence, pleadings, and correspondence that are generated and used in a litigation, especially a complex high-stakes litigation, may be stored and accessed in a computer-based system. Litigation support software enables a lawyer to use a web-based interface provided by a server to store, find, and view materials that are needed and to interact with others who are working on the case.

### SUMMARY

In general, in one aspect, the invention features a method that includes (a) storing, on a server, information useful for simultaneously managing progress of multiple litigations, the information for each of at least some of the litigations being stored for a period of time that extends beyond the resolution of the litigation, and (b) making at least some of the stored information available to authorized users through a user interface expressed in mark-up language pages.

Implementations of the invention may include one or more of the following features. In some examples, the multiple litigations are of a particular kind, such as class action, consumer fraud, sales practice, market conduct, claim denial, and/or punitive damage litigations, and the features of the invention are arranged to make management of such litigations especially effective. The kinds of clients or defendants that can be well-served by the features of the invention include companies, such as financial services firms, and especially insurance companies and/or their affiliates. The multiple litigations share at least one common feature that is used in managing the progress of the litigations. The common feature is at least one of (a) a particular law firm's involvement in all of the litigations, (b) the identity of a defendant, its affiliates, or plaintiff (and/or plaintiffs counsel) in the litigations, (c) the subject matter of the litigations, or (d) the field of law involved in the litigations. One of the mark-up language pages is a case home page that lists the litigations and key information associated with each of the litigations. The key information is expressed as hyperlinks.

The stored litigation management information includes at least one of (a) the status of each of the litigations or (b) the jurisdiction in which each of the litigations is pending.

The user interface includes a navigation bar that contains a list of litigation management functions to be performed. The user interface includes a search capability that enables each of the users to search the stored information. The search capability includes text-based key-word searching on documents included in the stored information. The search capability includes invocation of pre-done database searches. Pre-done database searches are invoked by hyperlinks displayed on the mark-up language pages. The results of the pre-done database searches are displayed as the mark-up language pages.

The mark-up language pages include document home pages that contain data about respective documents included in the stored litigation management information. The document home pages include information about relationships between documents. The mark-up language pages include case home pages that contain data about the respective litigations. The mark-up language pages include pleading file home pages that contain data about pleadings for given ones of the litigations. The stored information includes lawyer fees and costs for each of the litigations. The lawyer fees and costs are sortable and searchable with respect to the litigations.

Some of the stored information is made available to the authorized users in a portable document format (e.g., a fat pdf file) including searchable text information. The stored management information includes higher level management tables, and the other stored information includes full-text documents.

Other advantages and features will become apparent from the following description and from the claims.

### DESCRIPTION

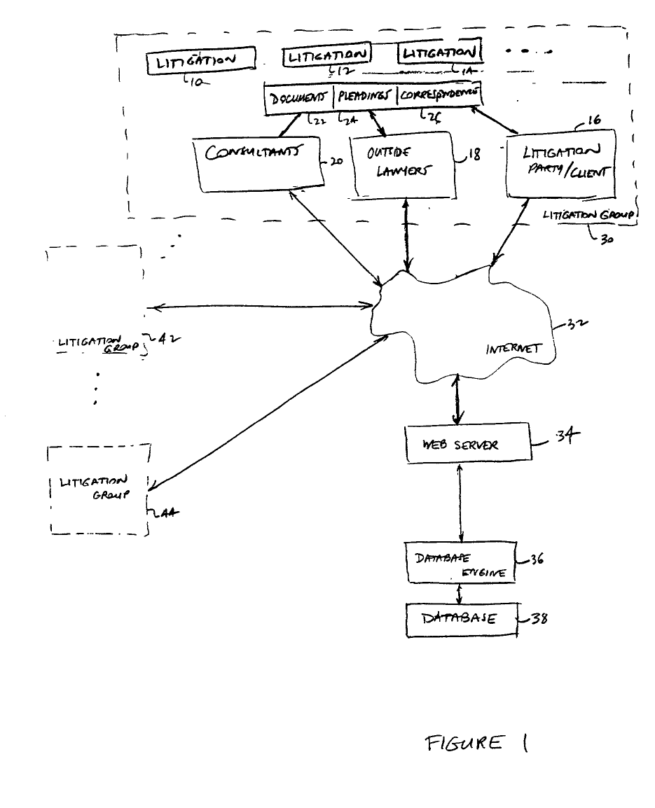

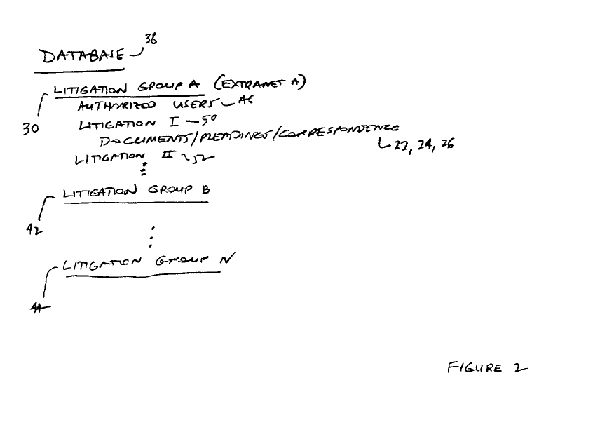

FIG. 1 shows a litigation management system.

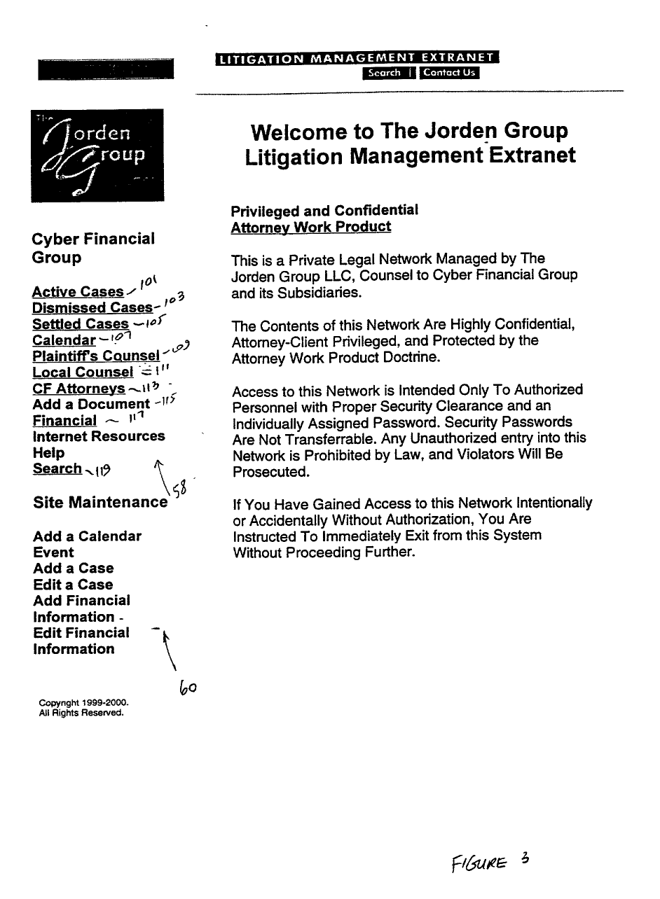

FIG. 2 shows a database.

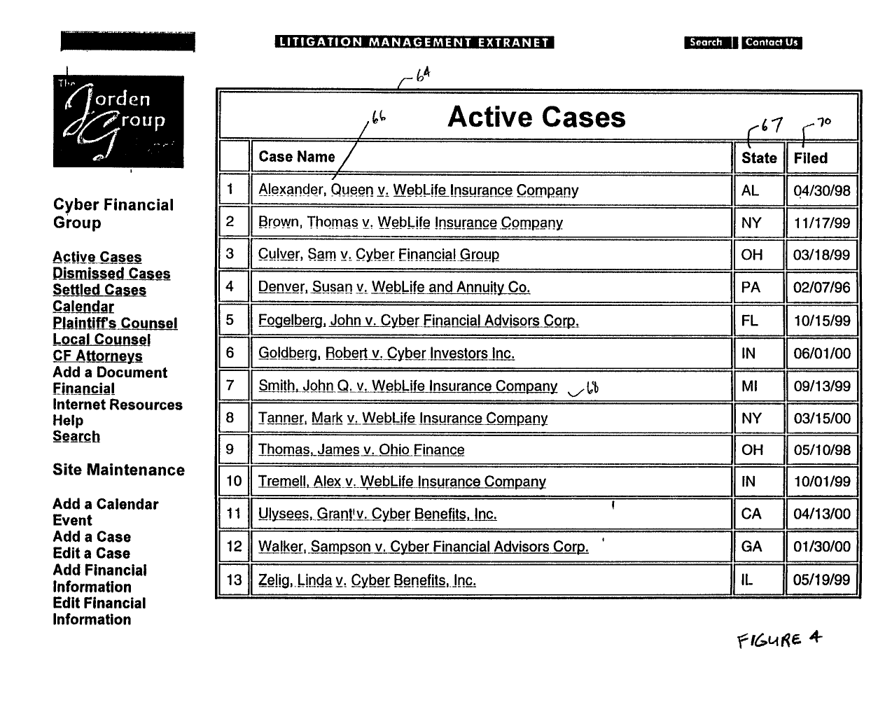

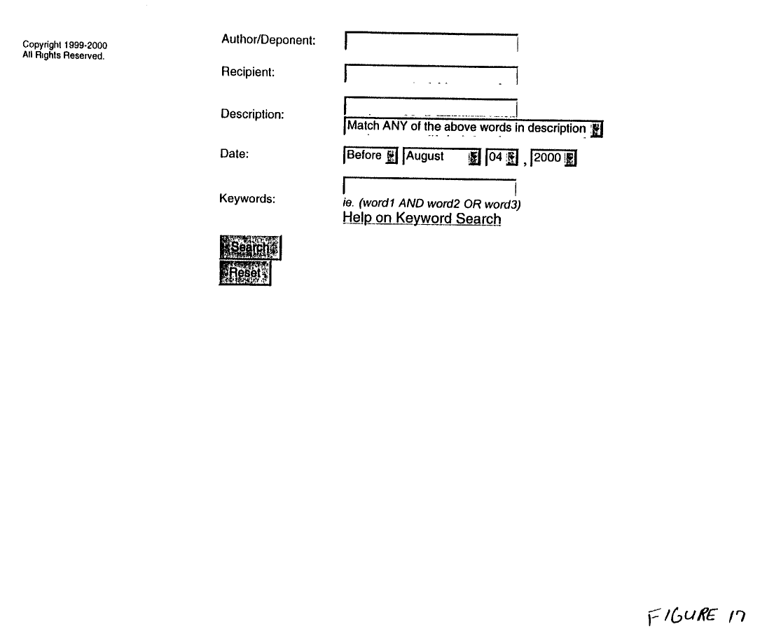

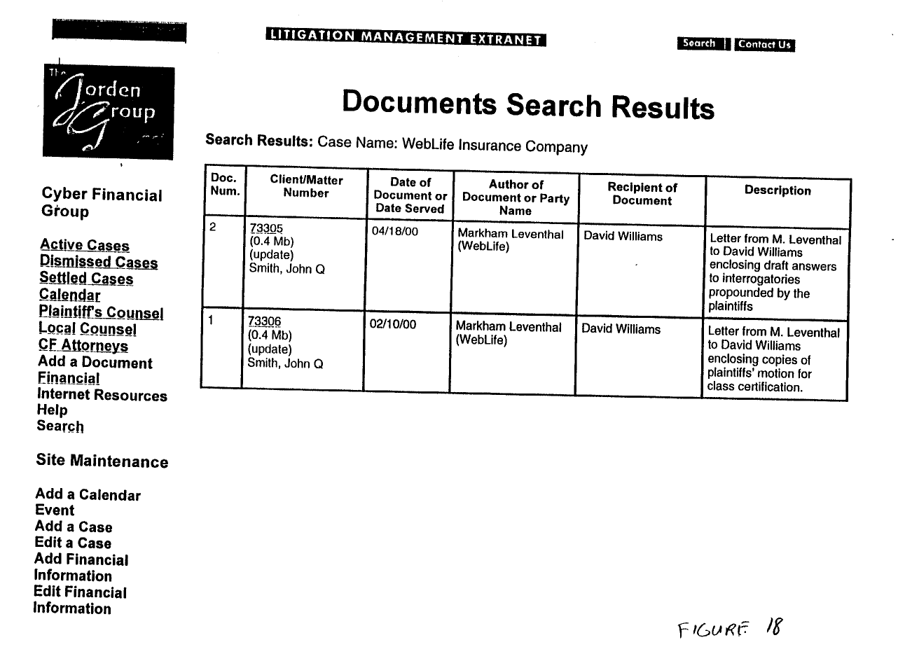

FIGS. 3 through 30 show web pages of a user interface.

As shown in FIG. 1, multiple litigations 10, 12, 14 to which a client 16 is a party and which are pending at different times in different jurisdictions may be managed effectively in an extranet that is accessible essentially from anywhere in the world to authorized users including employees and agents of the client, outside lawyers 18, and consultants 20.

Each litigation is represented by documents and other evidence 22, pleadings 24, correspondence 26, and other papers and materials (not shown) that are of importance to the users with respect to managing the progress of the litigations. In one example, the client may be an insurance company that is party to multiple complex litigations (in addition to the usual large number of claims matters). The party/client, the papers, and the litigations can together be thought of as a litigation group 30. The invention is especially useful for in-house counsel in a financial services company, such as an insurance company, who is charged with managing but not actually conducting multiple litigations of certain kinds such as class action, consumer fraud, sales practices, market conduct, claim denial, and/or punitive damages litigations. The invention enables the company and its outside counsel and consultants to build a database of multiple litigations over time for use in maintaining institutional memory and enabling effective litigation management. The choices of information to be stored and made available, the features to be provided for using the information, and the manner in which the information and features are presented to a user through a user interface are all made with a focus on the job of multiple litigation management of particular kinds rather than on generally managing unrelated litigations or on conducting litigations.

The extranet for litigation group 30 is accessible through conventional web browsers controlled by the authorized users, and the Internet 32. HTML-encoded web pages are delivered to the browsers by a web server 34 in response to requests and input of the users. The web pages are constructed on-the-fly using, among other things, information obtained through a database engine 36 from a database 38.

As shown in FIG. 2, the database contains a set of data for each of several different litigation groups 30, 42, 44. The data for each litigation group includes information about the authorized users 46 (used to control access to the databases) and other conventional housekeeping information associated with the group and the related extranet. The database is arranged to preclude access to any of the litigation groups by a user who is authorized only with respect to other litigation groups. The portion of the database that pertains to a given litigation group and the process of serving pages to users based on that portion may be thought of as an extranet. The database portion contains information needed by the web server to assemble and serve web pages for each of the extranets in a format and style that has been predefined for that extranet. Thus, different extranets served by the database may have different “look and feel” characteristics.

The rest of the data for each litigation group is organized by litigation. Two litigations 50, 52 of litigation group A are illustrated in FIG. 2. Each litigation section stores copies of the documents, pleadings, and correspondence 22, 24, 26 for that case. Each litigation section also stores other information (not shown) including organizational information (for example, the jurisdiction, docket number, and law firm responsible) and the results of the pre-done searches for certain information that can be served rapidly in response to user request.

The documents, pleadings, and correspondence can be stored in text form (e.g., as a Word document in the case of a complaint) or as a scanned image (for example, in .bmp format), or as a portable document formatted version (e.g., an Adobe pdf format) of a scanned image. In the case of an Adobe pdf format document, the format can be so-called fat pdf, which includes not only image information but also optical-character-recognized words that appear in the document. An index can be built from the fat pdf recognized words for use in rapid text searching by users.

Although it might be possible to use the system described to do the actual work of litigation, e.g., document review, writing briefs, developing case strategy, the system is configured to be especially useful in managing the progress of the litigations for the purpose of improving the results, enhancing the confidence of the party whose cases are being managed, and reducing the costs. Because the complement of in-house and outside lawyers working on multiple cases for a client may change from time to time, the system also helps to maintain the institutional memory that would otherwise be lost by the change of personnel.

FIGS. 3 through 30 show web pages that are part of the user interface offered by a hypothetical extranet for the Cyber Financial Group. In some cases, the web pages include drop-down lists that are only partially shown in the figures. The full lists of items available in each drop down list can be found in the Appendix filed with this application, which contains the HTML source code associated with those figures.

The features and facilities made available to the user of the litigation management system and the manner of presenting the features and facilities are selected (a) to enable a user to make intuitive rapid use of the system, (b) to exclude from the user options that are not relevant to the core job of simultaneously managing multiple litigations, and (c) to focus on the management of the progress of the litigations rather than to enable the users to actually conduct the litigation in all its detailed steps through the system.

To make the system most useful for litigation management, information about litigations is retained on the extranet and remains searchable even after the litigations are settled or otherwise terminated. This enables, for example, searching to identify all cases that have been or are currently being handled in a given jurisdiction.

As shown in FIG. 3, the initial screen presents a notice about confidentiality and includes a navigation bar on the left that carries through to other screens. The upper portion 58 of the navigation bar enables a user to navigate to other pages that enable the user to perform the main user functions of the system. The lower portion, which is displayed only to administrative users, provides links to other pages where administrative tasks may be performed.

The system and its functions are organized conceptually around the following basic tasks and elements that are important for management of multiple litigations for a party: cases, counsel, documents, financials, and a calendar.

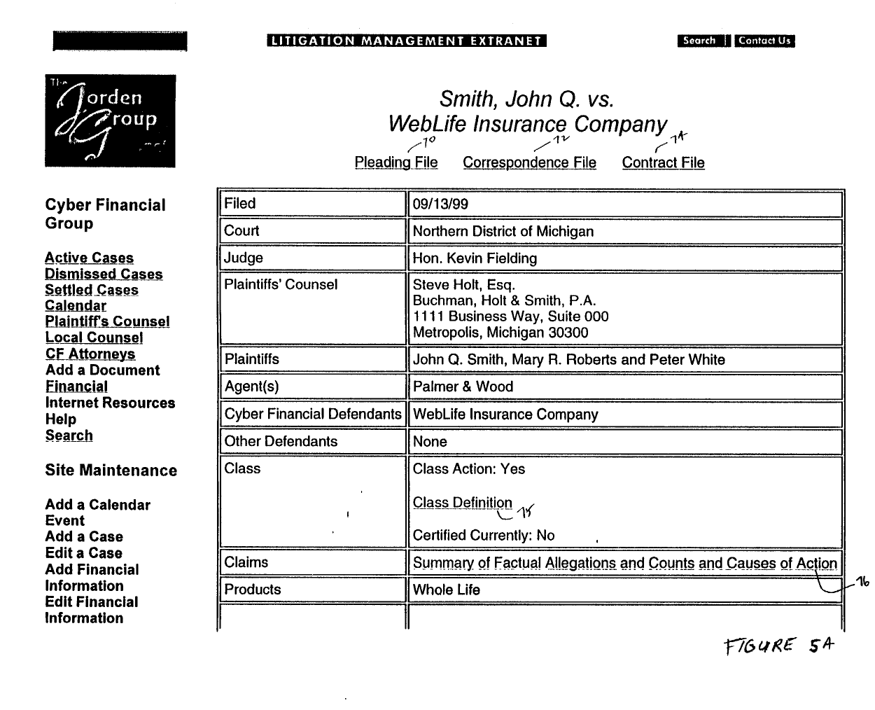

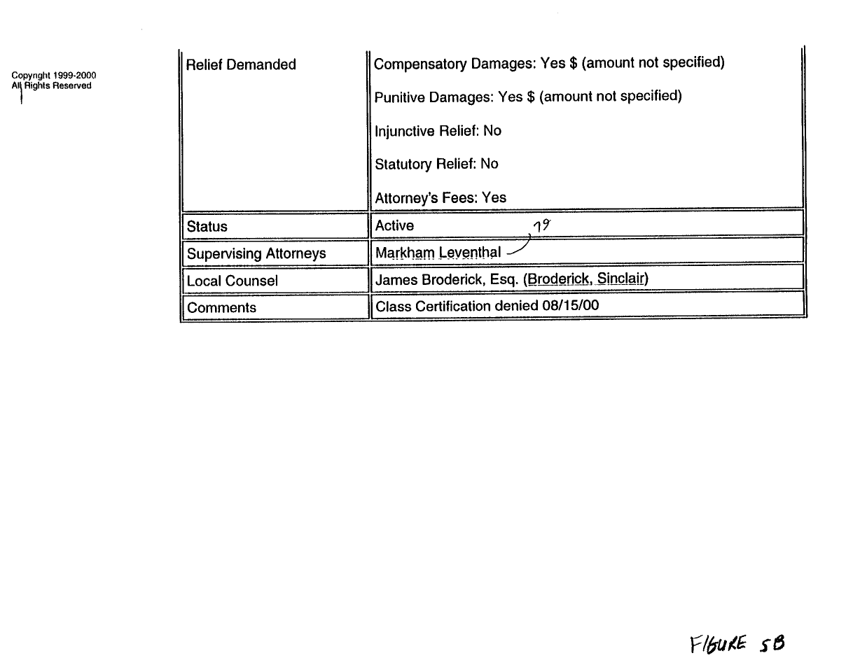

When the active cases link 101 in the navigation bar is invoked, the page shown in FIG. 4 is presented. The page shows, in table form, a list of all of the active cases 66 being managed, indicating the state 67 in which the case is pending and the date of filing 70. For simplicity and ease of understanding and using these key features of each case, no other information is presented on this screen. Each case is displayed as a hyperlink. By invoking the name of the case, such as the Smith v. WebLife case 68, the case home page shown in FIGS. 5A and 5B is presented. Three key links are offered at the top (their position and simplicity makes it easy and intuitive for a user to get what he wants and not be confused by other links that are not needed), one to the pleading file 70, one to the correspondence file 72, and one to the contract file 74. Pages similar to FIG. 4 are displayed in response to links 103 and 105 of FIG. 3.

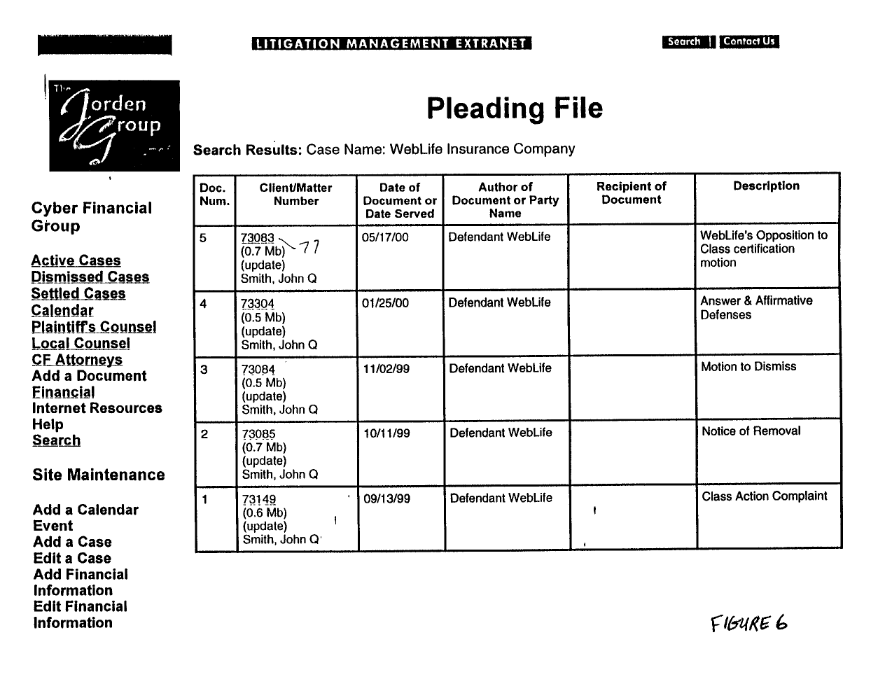

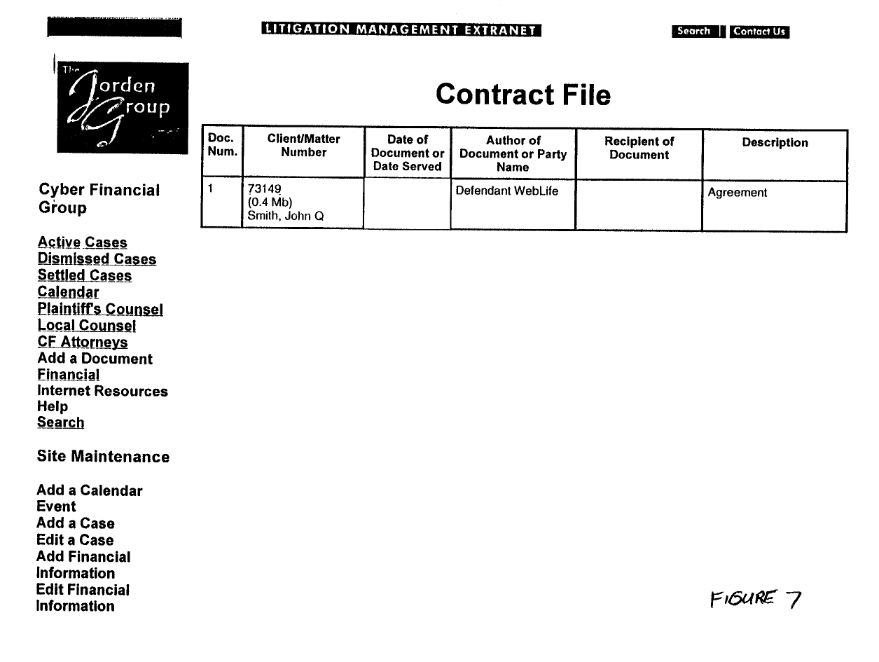

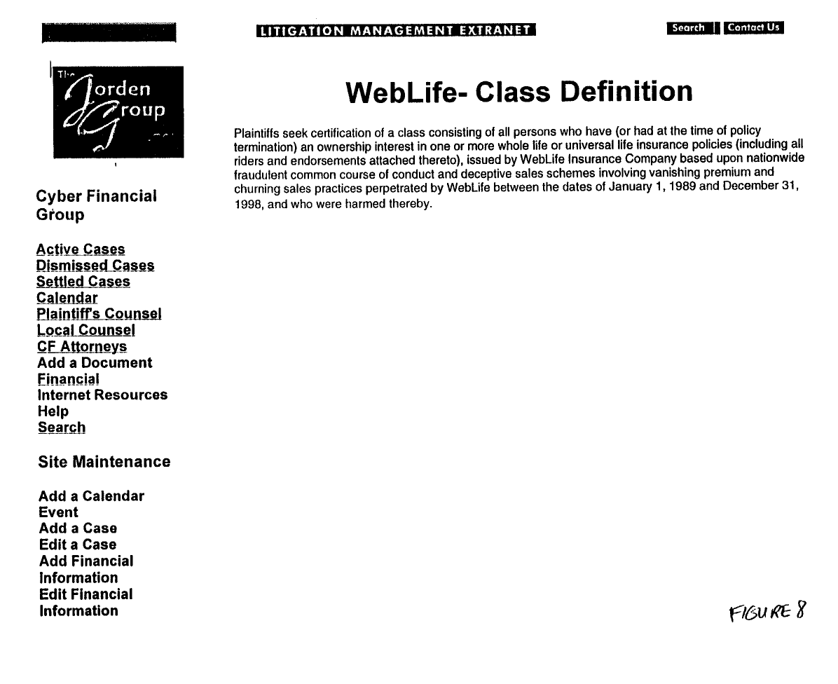

The pleading file and contract file links lead to the pages shown in FIGS. 6 and 7 (the correspondence file link leads to a similar page, not shown). Invoking the pleading file link, for example, triggers the server to fetch and serve the results of a pre-done search of the database. That is, the search within the document records for all documents of type “pleading” is done each time the database records are updated, and the results of the search are stored. When the user later invokes the pleading file link, the pre-done search results are served to the user. This assures a quick response time. A variety of other pre-done searches are used to quickly respond to other links offered to the user.

On FIG. 6, each document is identified by a document number 77 displayed as a hyperlink. If the link is invoked, the system fetches and displays that document in pdf format to the user. A similar approach is used to invoke documents on other pages.

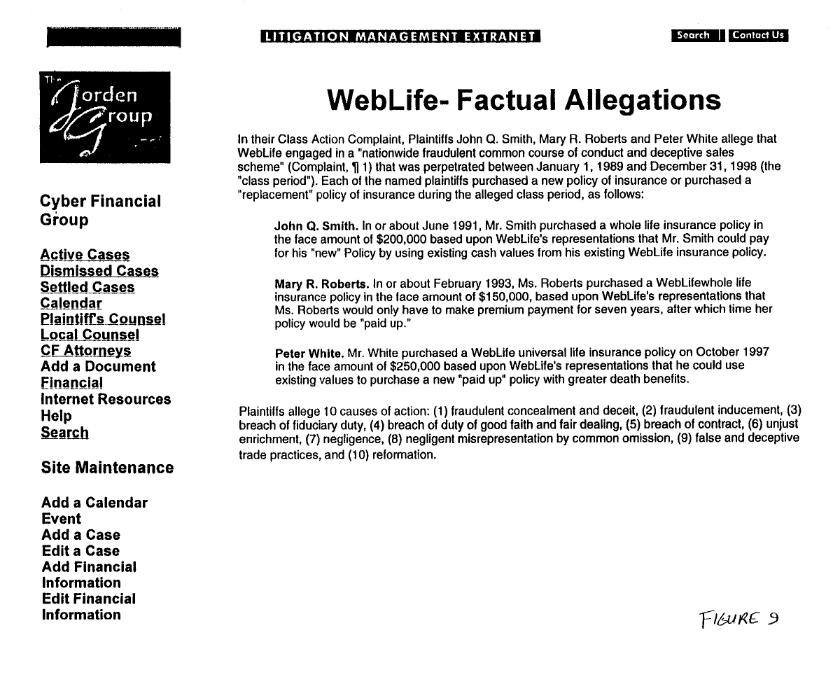

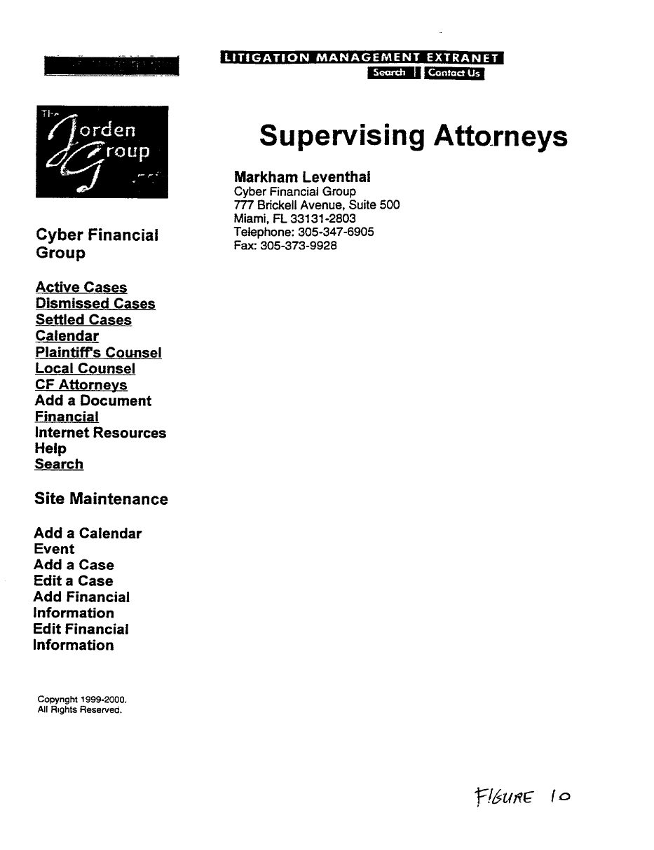

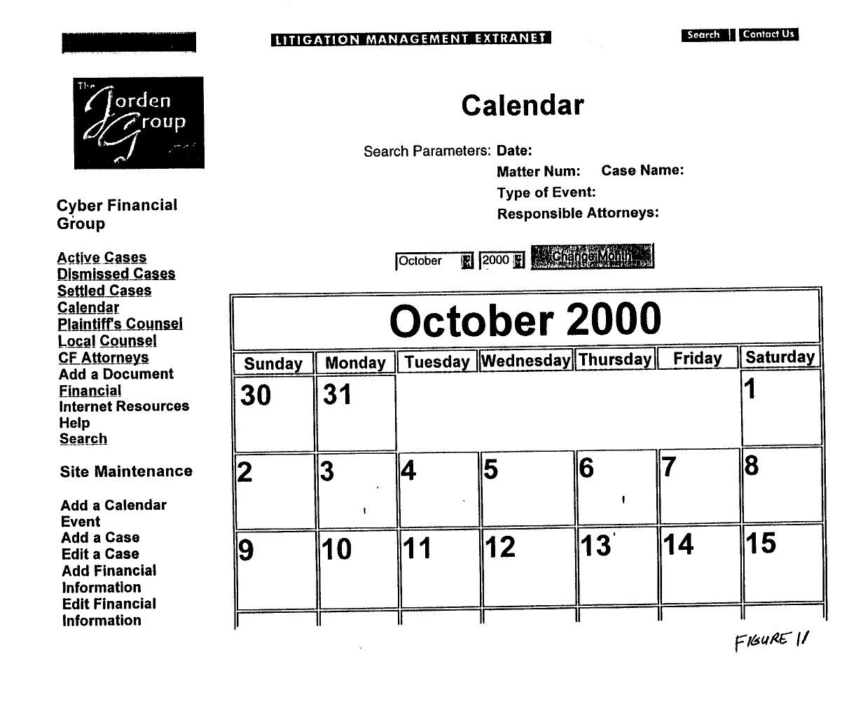

Returning to FIG. 5A, if the user invokes the class definition link 75, the page shown on FIG. 8 is presented. The information is presented in text form rather than as an image of a document. The link 76 on FIG. 5A similarly triggers the presentation of the page shown in FIG. 9; and the link 79 on FIG. 5B leads to the page shown in FIG. 10.

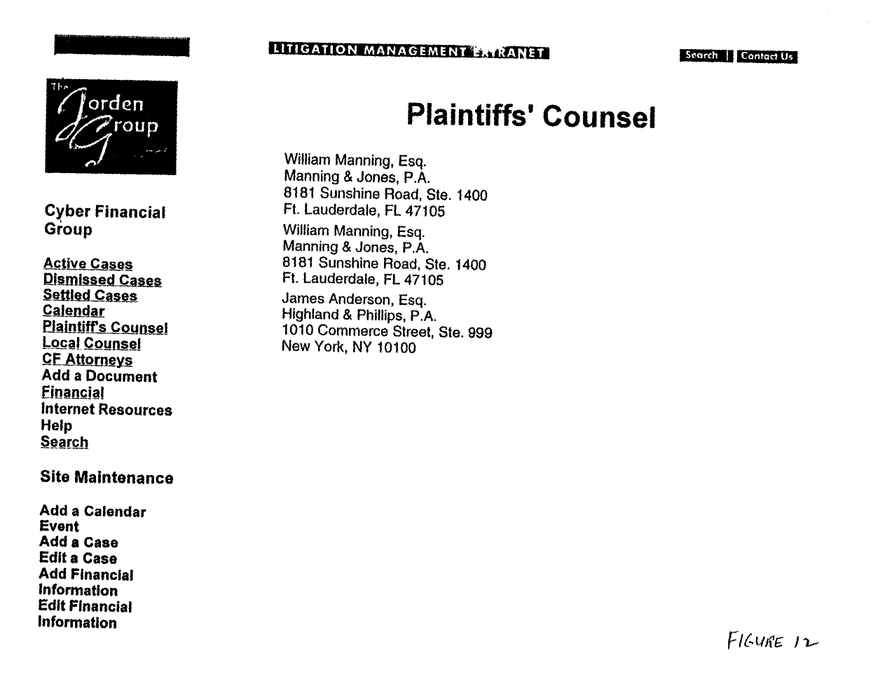

The calendar link 107 on FIG. 3 leads to the calendar feature shown in FIG. 11.

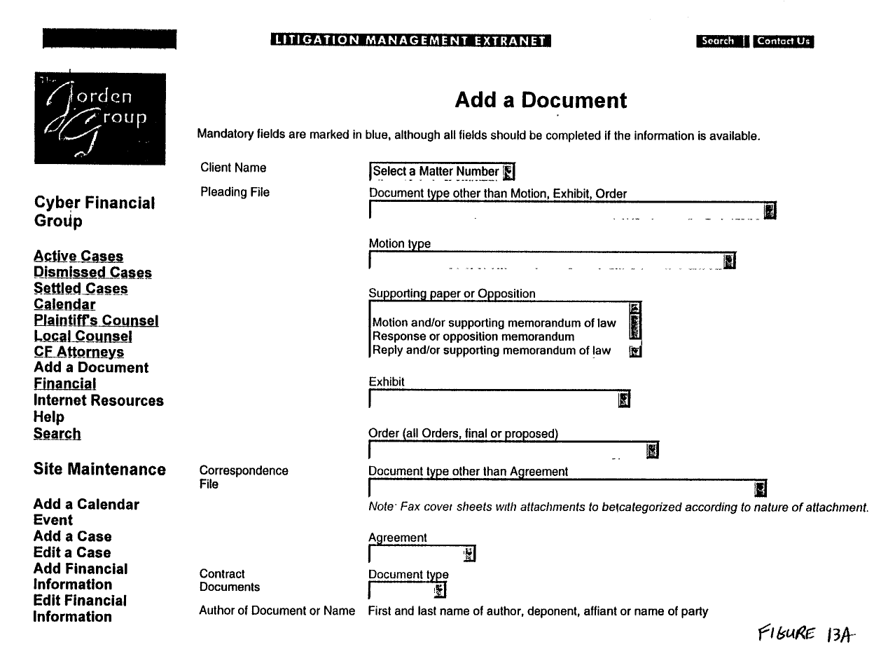

When the Plaintiffs counsel, Local counsel, or CF counsel links 109, 111, 113 on FIG. 3 are invoked, a page like the one shown in FIG. 12 is displayed, including key contact information for lawyers working on the litigation. This information is provided directly in text rather than as a document image.

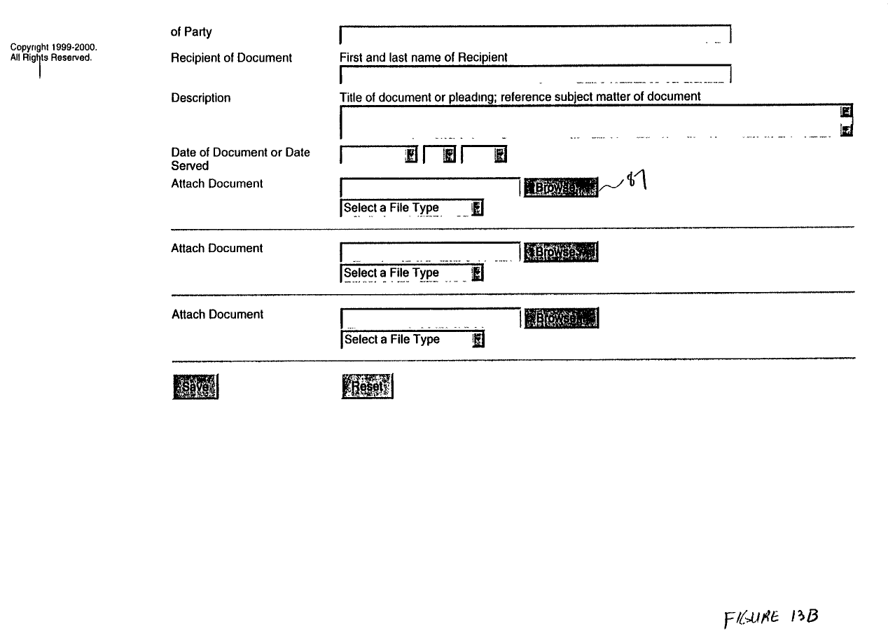

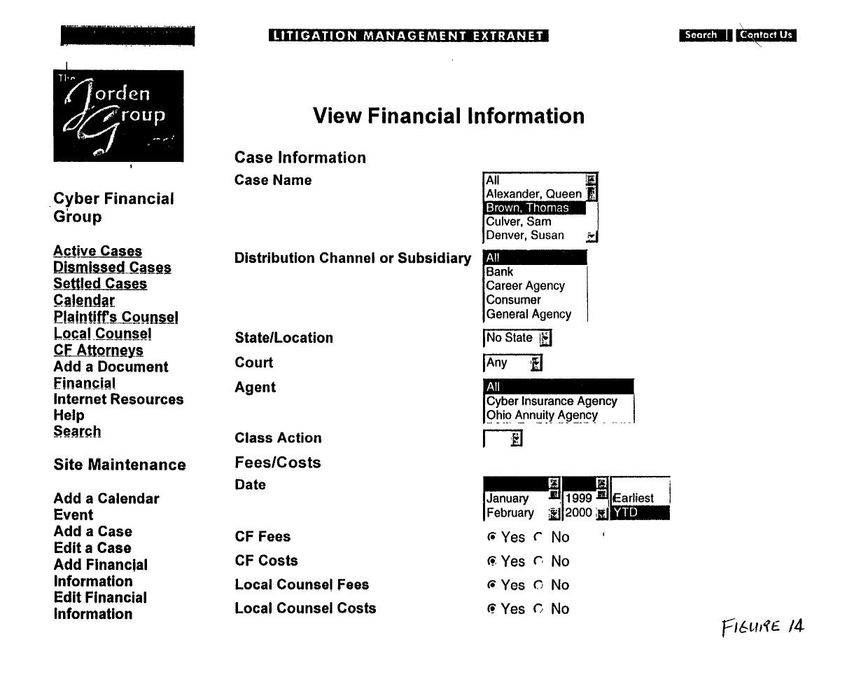

By invoking link 115, an authorized user may add a document to the system using the input boxes shown in FIG. 13A. The document can be placed in any of the three files for pleadings, contracts, or correspondence, as shown, and certain cataloging information (that is usable later for searching purposes) is added using drop down boxes.

A button 87 on FIG. 13B enables the user to browse for a document that has been cataloged in the earlier boxes and is ready to be uploaded, stored in the database, and indexed.

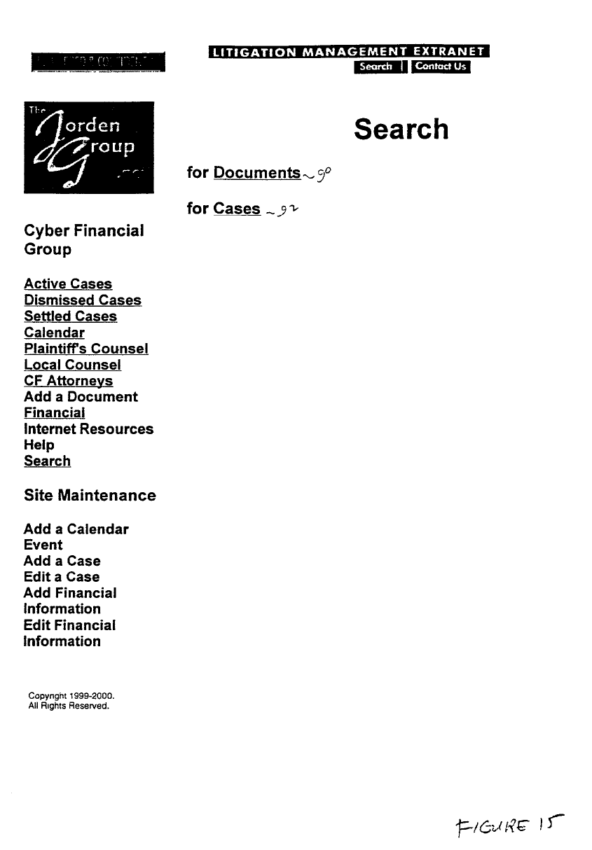

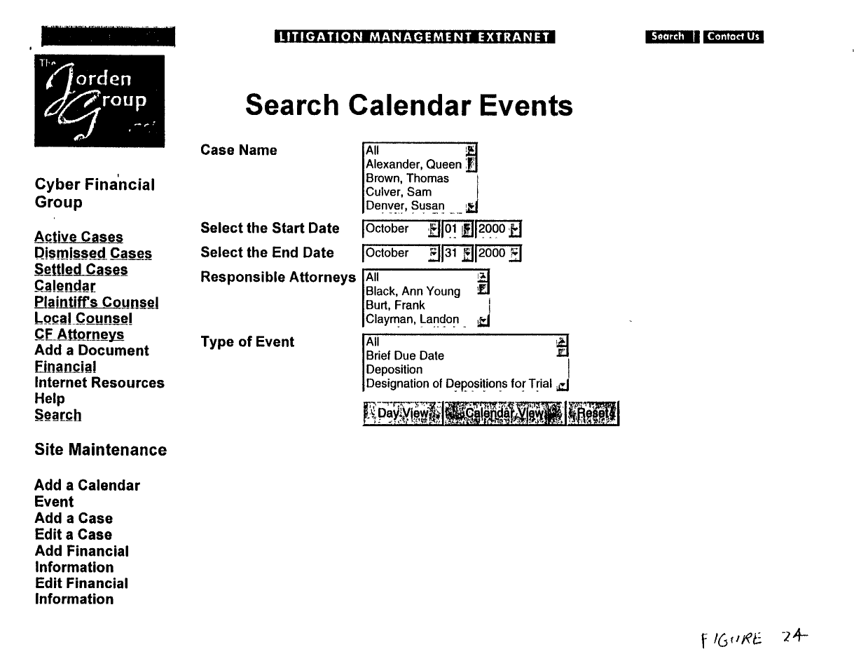

The system provides financial information from the accounting system of the outside law firms to the users of the system, enabling cost control. The financial information is uploaded periodically from the law firm accounting system to the database at the server. When the financial link 117 on FIG. 3 is invoked, the page shown on FIG. 14 is displayed to the user. When the user has indicated the search criteria, financial information of the kind shown on FIG. 23 is displayed.

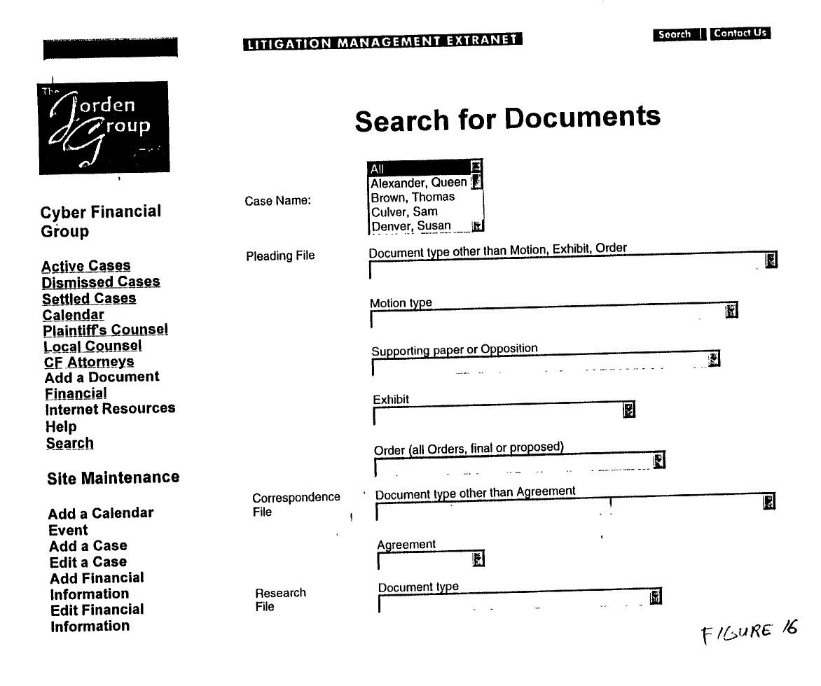

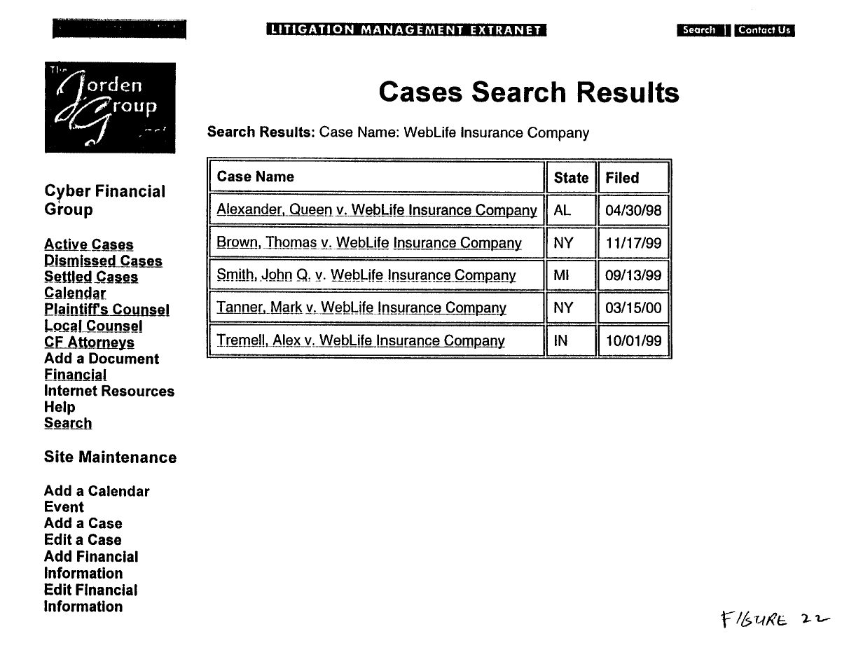

In addition to the pre-done searches that support links on the pages of the system, the user may invoke the search link 119 on FIG. 3 and be taken to the page shown in FIG. 15. That page offers simple options (two in this case) that are focused on the two key kinds of information typically needed for litigation management: documents 90 and cases 92, which lead respectively to FIGS. 16 and 21A. In those figures, the user may make a search for documents or cases using a combination of drop down boxes that pick predefined values for key parameters and using a keyword search box that permits a text search.

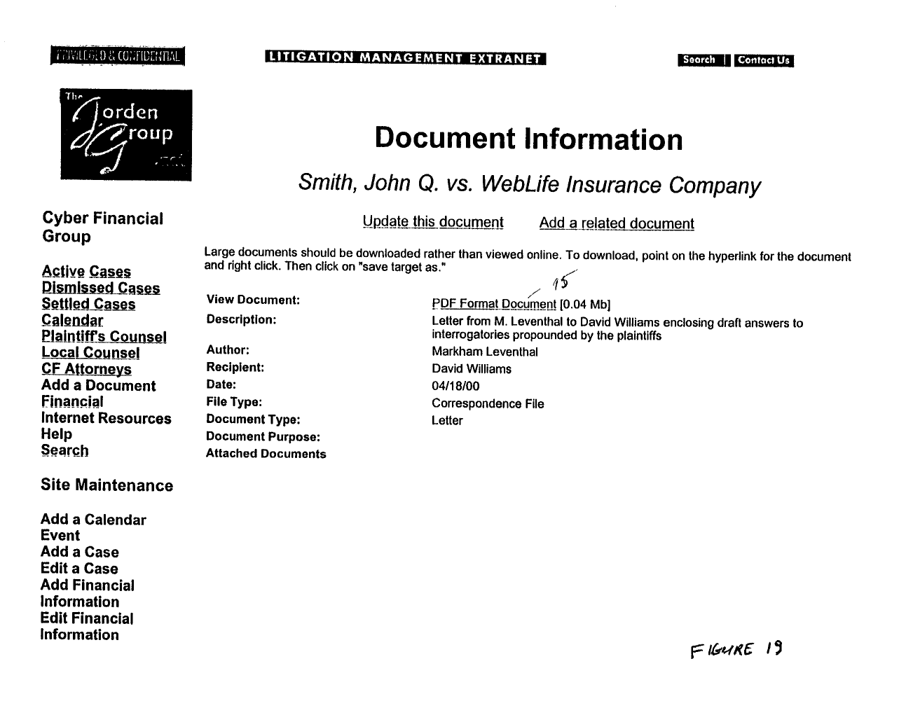

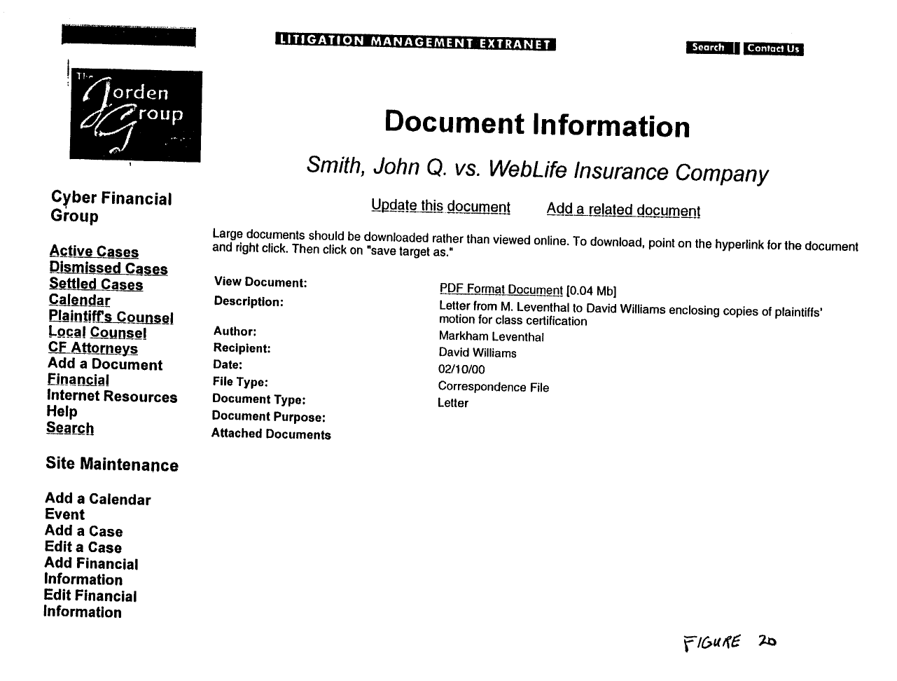

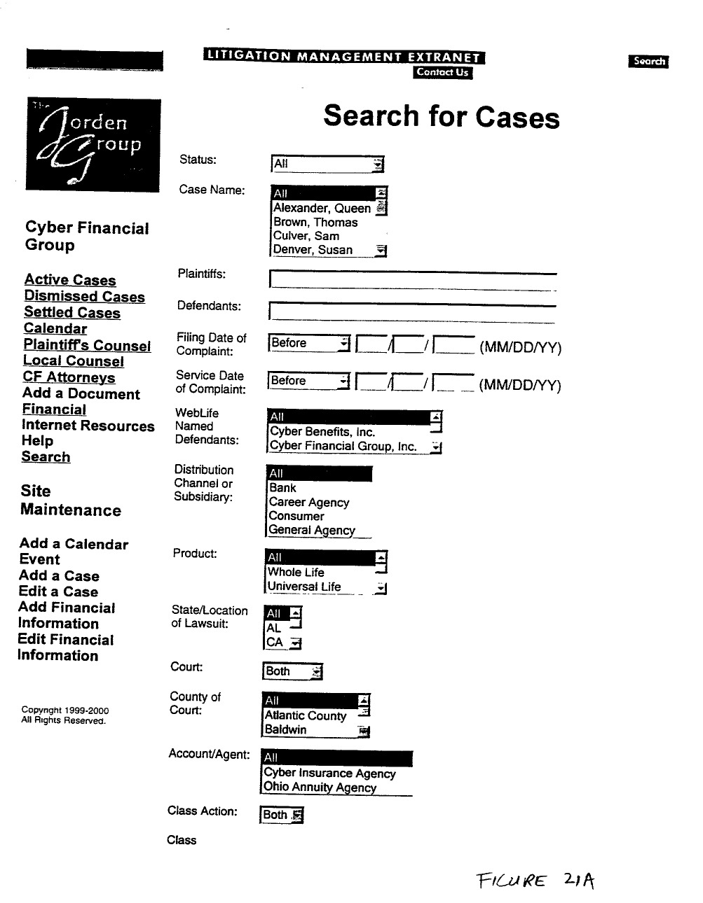

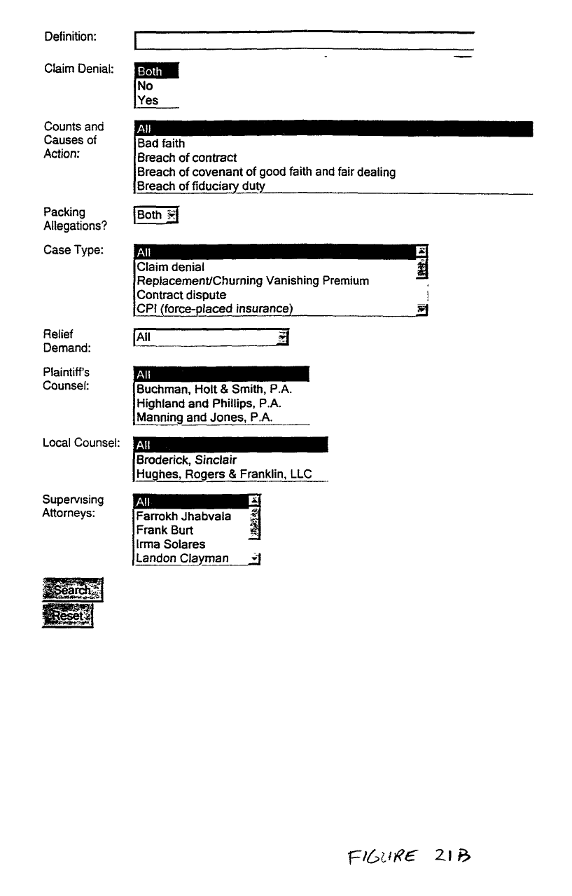

The results of a document search are shown on FIG. 18 as a table. FIGS. 19 and 20 show document home pages that are displayed when one of the document numbers on FIG. 18 is invoked.

The document home page includes information within predefined cataloging parameters, and provides a link 95 to a pdf version.

Two links 96, 97 at the top of the page enable a user to invoke the updating and adding features with respect to documents. Again, because of the careful and simple choice and positioning of links, the user is able to intuitively and quickly take the steps that he intends without being confused by irrelevant options.

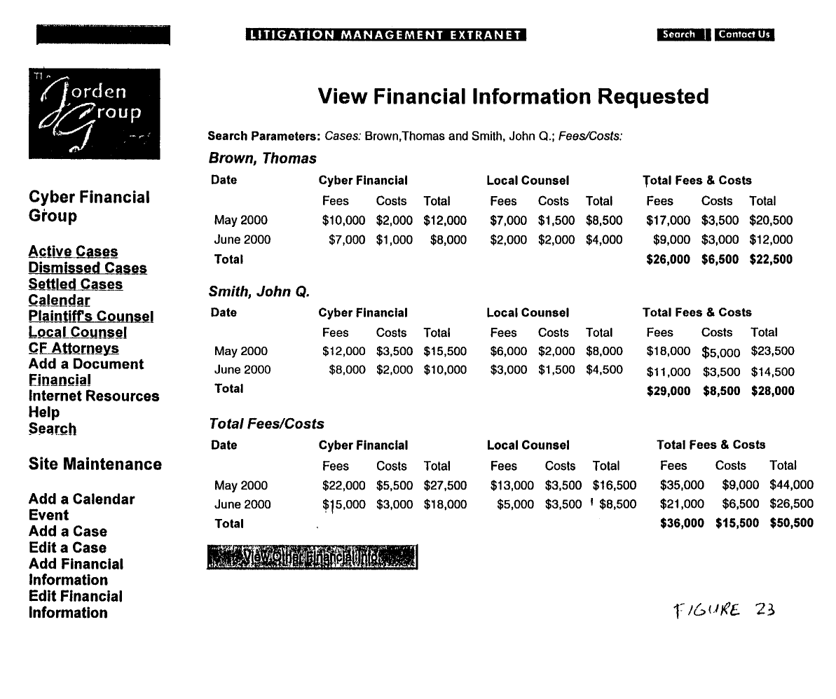

FIG. 22 shows the results of a case search. Each case can be invoked to reach the case home page as explained before.

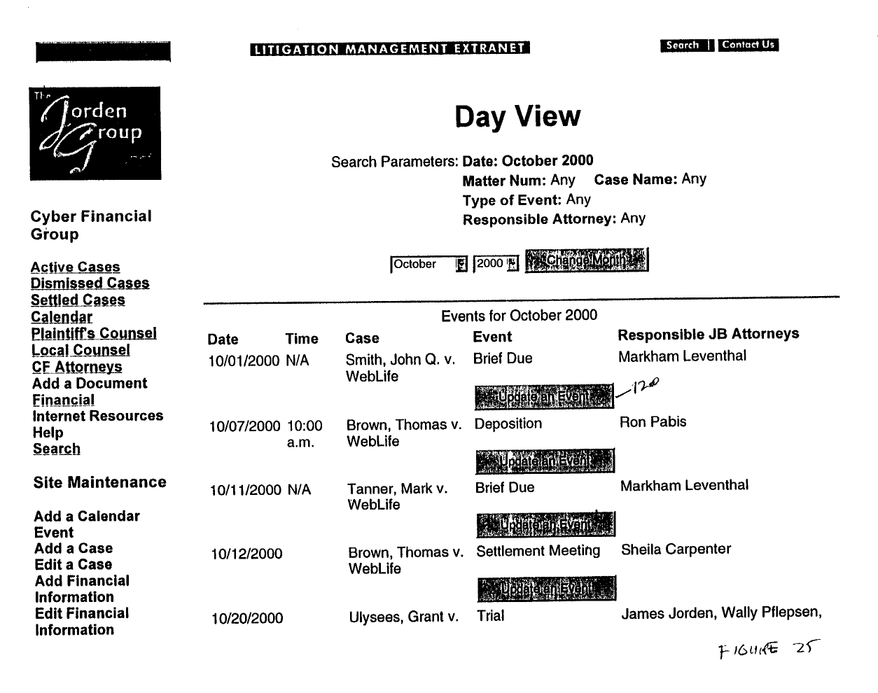

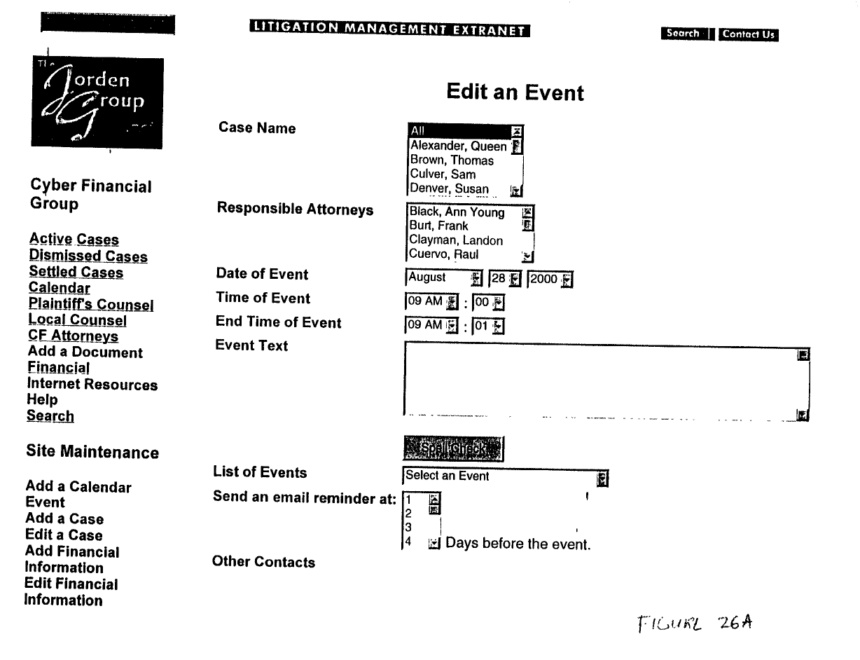

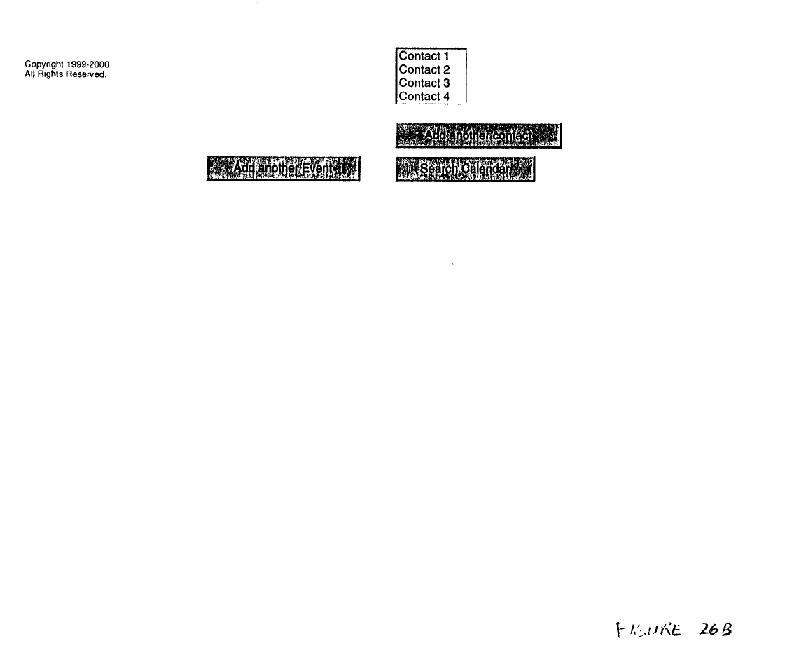

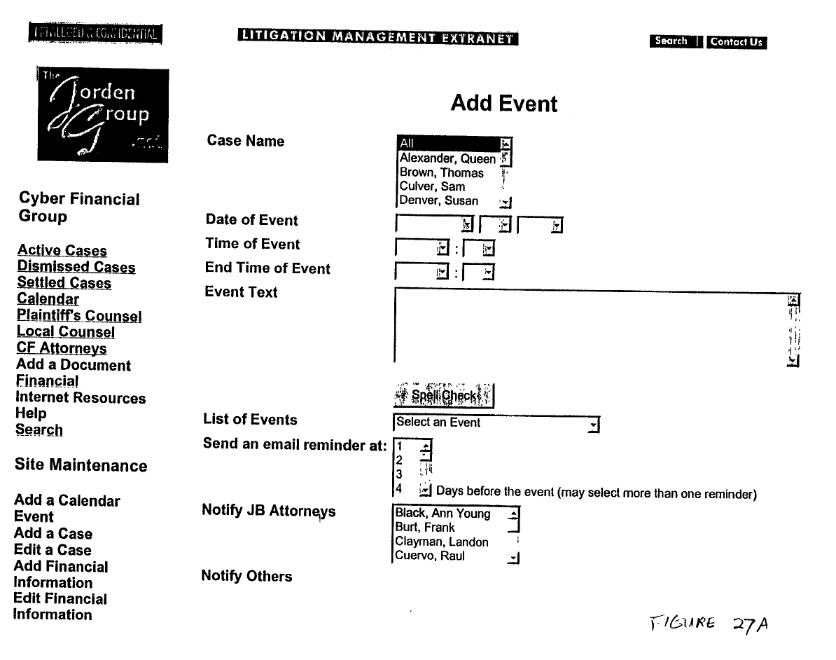

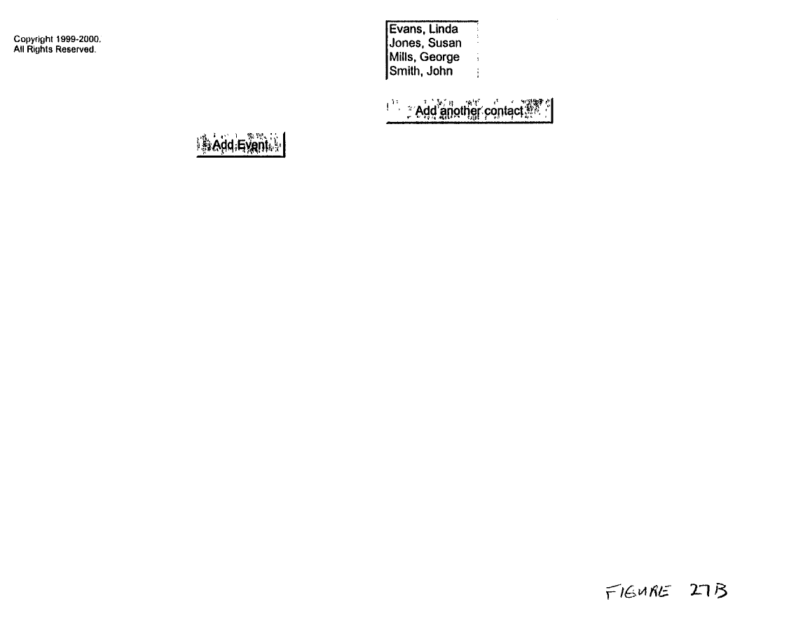

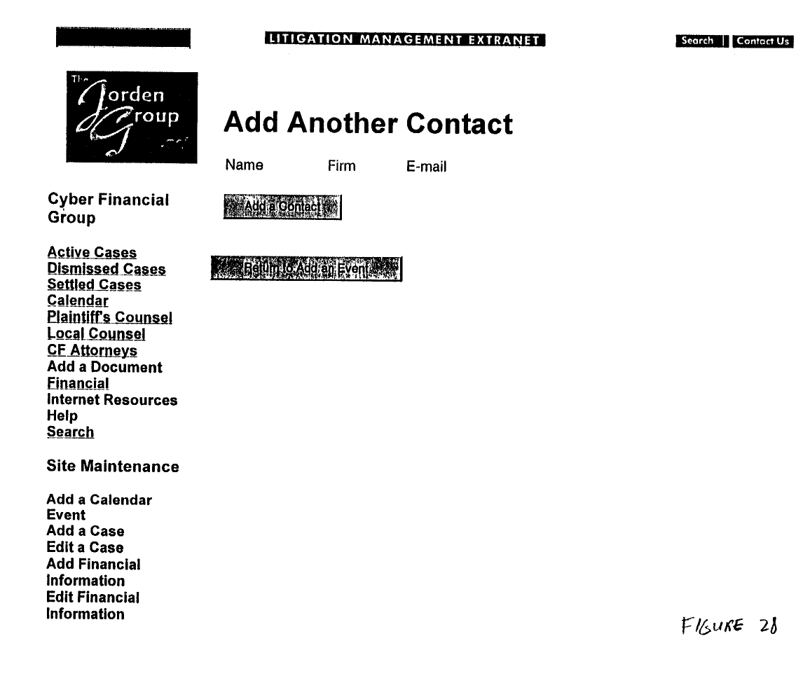

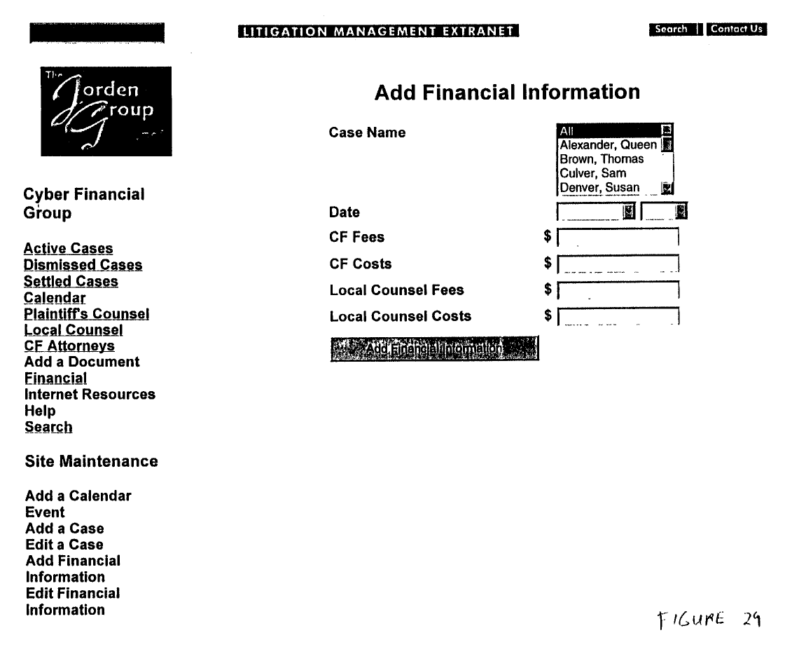

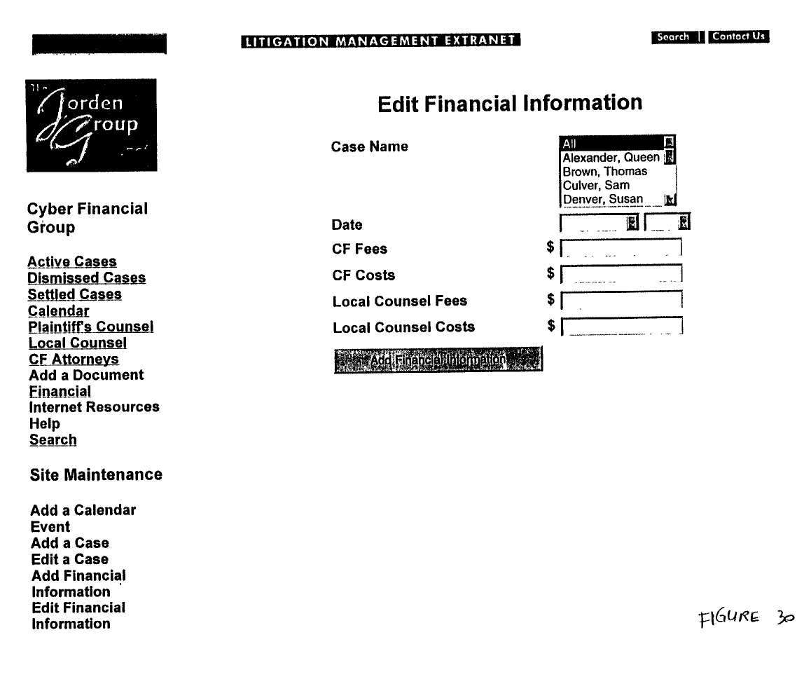

FIG. 24 shows a search page that enables a search for calendar events. FIG. 25 shows a day view of events on the calendar. Each event has an “update event” button 120 that leads to the page shown in FIGS. 26A and 26B. An event can be added using the facilities provided on the page shown in FIGS. 27A and 27B. A contact list can also be maintained and supplemented using the page shown in FIG. 28. Financial information can be added and edited using the pages shown in FIGS. 29 and 30.

Other implementations are within the scope of the following claims.

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

1. A method comprising
storing, on a server, information useful for simultaneously managing progress of multiple litigations, the information for each of at least some of the litigations being stored for a period of time that extends beyond the resolution of the litigation, and
making at least some of the stored information available to authorized users through a user interface expressed in mark-up language pages.

2. The method of claim 1 in which the multiple litigations comprise one or more of class action, consumer fraud, sales practice, market conduct, claim denial, or punitive damage litigation.

3. The method of claim 1 in which the multiple litigations are for clients that comprise companies.

4. The method of claim 3 in which the clients comprise financial services firms.

5. The method of claim 4 in which the clients comprise insurance companies and their affiliates.

6. The method of claim 1 in which the multiple litigations share at least one common feature that is used in connection with the managing of progress.

7. The method of claim 6 in which the common feature comprises at least one of (a) involvement in all of the litigations of a particular law firm, (b) the subject matter of the litigations, (c) the field of law involved in the litigations, or (d) the identity of a defendant or plaintiff in the litigations.

8. The method of claim 6 in which one of the mark-up language pages comprises a case home page that lists the litigations and key information associated with each of the litigations.

9. The method of claim 8 in which the key information is expressed as hyperlinks.

10. The method of claim 1 in which the stored information useful for managing multiple litigations includes at least one of (a) the status of each of the litigations and (b) the jurisdiction in which each of the litigations is pending.

11. The method of claim 1 in which the user interface includes a navigation bar that contains a list of litigation management functions to be performed.

12. The method of claim 1 in which the user interface includes a search capability that enables each of the users to search the stored information.

13. The method of claim 12 in which the search capability includes text-based key-word searching on documents included in the stored information.

14. The method of claim 12 in which the search capability includes invocation of pre-done database searches.

15. The method of claim 14 in which the pre-done database searches are invoked by hyperlinks displayed on the mark-up language pages.

16. the method of claim 14 in which the results of the pre-done database searches are diplayed as the mark-up language pages.

17. The method of claim 1 in which the mark-up language pages include document home pages that contain data about respective documents included in the stored information.

18. The method of claim 17 in which the document home pages include information about relationships between documents.

19. The method of claim 1 in which the mark-up language pages include case home pages that contain data about the respective litigations.

20. The method of claim 1 in which the mark-up language pages include pleading file home pages that contain data about pleadings for given ones of the litigations.

22. The method of claim 1 in which the stored information includes lawyer fees and costs for each of the litigations.

23. The method of claim 22 in which the lawyer fees and costs are sortable and searchable with respect to the litigations.

24. The method of claim 1 in which the mark-up language pages comprise litigation management information and also including
making other stored information available to the authorized users in a portable document format.

25. The method of claim 24 in which the portable document format comprises a fat pdf file.

26. The method of claim 25 in which the portable document format comprises Adobe pdf format including searchable text information.

27. The method of claim 26 in which the stored information includes higher level management tables and the other stored information includes full-text documents.

28. A method comprising
storing, on a server, information useful for simultaneously managing progress of multiple litigations, the information for each of at least some of the litigations being stored for a period of time that extends beyond the resolution of the litigation, some of the information being stored in a portable document format,
making at least some of the stored information available to authorized users through a user interface expressed in mark-up language pages,
the multiple litigations share at least one common feature that is used in connection with the managing of progress,
the mark-up language pages including a case page that lists the litigations and key information associated with each of the litigations, pleading file home pages that contain data about pleadings for given ones of the litigations document home pages that contain data about respective documents included in the stored information case home pages that contain data about the respective litigations
the user interface including a navigation bar that contains a list of litigation management functions to be performed, a search capability that enables each of the users to search the stored information,
the stored information including lawyer fees and costs.

29. A website comprising
information that is stored on a server and is useful for simultaneously managing progress of multiple litigations, the information for each of at least some of the litigations being stored for a period of time that extends beyond the resolution of the litigation, and
mark-up language pages that express a user interface in which at least some of the stored information is made available to authorized users.

30. A server comprising
stored information that is useful for simultaneously managing progress of multiple litigations, the information for each of at least some of the litigations being stored for a period of time that extends beyond the resolution of the litigation, and
an engine that generates mark-up language pages in response to users' litigation management requests, using the stored information, and serves the pages to authorized users.
